(19) United States
(12) Patent Application Publication
(10) Pub. No.: US 2014/0227167 A1
(43) Pub. Date: Aug. 14, 2014

(54) Oxidative Attack and Elimination of Bisphenol A by Manganese Dioxide

(71) Applicant: Peter Scott Welcker, III, Parkersburg, WV (US)

(72) Inventor: Peter Scott Welcker, III, Parkersburg, WV (US)

(21) Appl. No.: 14/157,631

(22) Filed: Jan. 17, 2014

Related U.S. Application Data
(60) Provisional application No. 61/764,158, filed on Feb. 13, 2013.

(51) Int. Cl. C01G 45/02

(52) U.S. Cl. CPC C01G 45/02
USPC 423/605

(57) ABSTRACT

Bisphenol A (BPA) has been the subject of public and regulatory attention, primarily because of concerns about its endocrine activity. BPA typically is used as an intermediate in the production of polycarbonate plastics and epoxy and other specialty resins. A process by which Bisphenol A can be oxidatively attacked and removed by manganese dioxide is discovered. Specifically, it relates to the process by which individuals could use manganese dioxide coated cooking utensils to remove the organic compound Bisphenol A (BPA) from canned foods and bottled beverages including, but not limited to, soft drinks, Cola-type beverages, juices and bottled drinking water.

### CROSS-REFERENCE TO RELATED APPLICATIONS

Provisional patent application pending U.S. 61/764,158

### STATEMENT REGARDING FEDERALLY SPONSORED RESEARCH OR DEVELOPMENT

Not Applicable—This research is not sponsored or paid for by any Federal agency.

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to the removal of the organic compound Bisphenol A (BPA, 4,4′-isopropylidine diphenol, CAS Registry No. 80-05-7) from consumables with special emphasis on BPA removal from canned foods and bottled beverages including bottled water. BPA is commonly found as a contaminant in canned foods eluting from can liners and in foods and beverages packed out in hard clear polycarbonate plastic containers. BPA is used as an intermediate in the production of polycarbonate plastics and epoxy and other specialty resins. Problems arise when BPA leaches into foods and beverages and are ingested by consumers. Other major applications for polycarbonate plastics containing BPA include glazing and sheeting, electrical and electronic goods, electronic storage media, and household goods such as bottles, utensils, and containers. Epoxy resins are used to provide protective coatings for architectural structures, marine and car materials, containers, and printed circuit boards. Bisphenol A is also used in the production of phenoplast, phenolic and unsaturated polyester resins, polyvinylchloride, and thermal paper. The presence of BPA in foods and beverages has been the subject of public and regulatory attention, primarily because of concerns about its endocrine activity.

The present invention is in the technical field of chemical remediation. More particularly, the present invention is in the technical field of aqueous remediation, including the removal of the organic compound Bisphenol A (BPA) from canned foods, bottled beverages including but not limited to, soft drinks, Cola-type beverages, juices and bottled drinking water.

2. Description of Related Art

There are currently no procedures or techniques published for the removal of BPA from canned foods or bottled beverages and none of the procedures for BPA removal from wastewater appear applicable by individuals desirous of removing BPA from purchased foods and beverages. Techniques for the removal of BPA from wastewater include adsorption to granular activated carbon (GAC), biological degradation in a continuous activated sludge (CAS) system or membrane bioreactor system (MBR), nanofiltration, and reverse osmosis. Advanced Oxidation Process (AOP) may be used when high-quality treated water, required for groundwater recharge and indirect potable reuse is required. This technology while expensive and time consuming makes it possible to achieve 99% BPA removal. AOP technologies include direct and indirect photo-catalysis including photo-catalysis with titanium dioxide, or chemical oxidation using either Ultraviolet/hydrogen peroxide (UV/H₂O₂), UV/Fenton reagent, or UV/Fenton/oxalate, or treatment using ozone, electrochemical processes, or ultrasonic cavitation.

All technologies currently in use for BPA removal from wastewater are expensive, time consuming, and are not applicable to the removal of BPA from consumer-based products. Furthermore, most technologies with the exception of AOS produce unacceptably low BPA removal rates.

### SUMMARY OF THE INVENTION

The present invention is a novel use of the paramagnetic transition metal compound manganese dioxide to oxidatively attack and eliminate BPA from canned foods containing BPA in can liners, or beverages in BPA containing plastics, including, but not limited to polycarbonates. Manganese dioxide (MnO₂, CAS Registry No. 1313-13-9) is the primary component of the mineral pyrolusite. Manganese dioxide is commonly used in production of dry-cell batteries, matches, fireworks, porcelain and glass-bonding materials, amethyst glass, and as the starting material for production of other manganese compounds. It is manganese dioxide's strong oxidative ability that has delivered a new use for this common compound as the perfect “cleanup tool” for BPA. Specifically, MnO₂ coated onto the surface of items such as cooking utensils, including, but not limited to, spoons, stirring devices, strainers, pots, pans, etc. has proven capable of effectively and inexpensively removing BPA.

### BRIEF DESCRIPTION OF THE DRAWINGS

Not Required

### DETAILED DESCRIPTION OF THE INVENTION

The present invention relates to a process for the oxidative attack and elimination of Bisphenol A (BPA) by manganese dioxide (MnO₂). Specifically, it relates to the process by which individuals could use MnO₂ coated cooking utensils to reduce the concentration or remove completely BPA from canned foods and bottled beverages.

Referring now to the invention in more detail; a fine coating of manganese dioxide adhered to the surfaces of cooking utensils allowing the manganese dioxide to come into contact with BPA molecules in solution initiates the process of oxidative coupling.

Oxidative coupling results in the formation of dimeric products thus effectively removing BPA from solution. BPA removal was directly related to MnO₂ concentration.

In more detail, MnO₂ levels of 800 μM resulted in 100% BPA removal. Using 400 μM MnO₂, BPA removal ranged from 10-80% depending upon contact time and pH. Comparison between granular activated carbon (GAC) and MnO₂ efficiencies was initially similar but MnO₂ continued removing BPA long after GAC saturation.

The advantages of the present invention include, without limitation, that simply coating cooking utensils with MnO₂ removed 97% of the BPA from treated chicken noodle soup while BPA removal from bottled water and soft drinks was 18-80% efficient. Although the BPA/MnO₂ complex formed during this reaction is extremely robust, pH determines the efficiency of the removal process with pH ranges of up to 4.5 being optimal. Soft drinks, Cola-type beverages and juices all fall into this optimal range. Coated food preparation utensils all simply and efficiently removed BPA from the domestic environment. The material holding the MnO₂ onto the coated cooking utensil may be any food safe adhesive. Additionally, electrodeposition of MnO₂ onto metallic cooking utensils was equally efficacious and increased durability and longevity of the cooking utensil's ability to remove BPA. Consumer goods such as bottled beverages or canned vegetables and soups containing BPA were efficiently decontaminated by simply stirring with a MnO₂ coated utensil.

In broad embodiment, the present invention is a simple and effective way of removing Bisphenol A from canned foods and bottled beverages.

The invention will now be further described with reference to the following examples without however the intention to limit the invention thereto. Practical embodiments of the present invention are shown in the following examples.

### EXAMPLE 1

Concentrations of MnO₂ greater than 800 μM removed 100% of the BPA in concentrations from less than 100 μM to over 32,000 μM. Increasing the concentration of MnO₂ always increased the rate of removal of BPA. Holding MnO₂ constant resulted in a lower percentage of BPA removal as BPA concentrations increased. Comparing the BPA removal rates of 400 μM MnO₂ to the removal rate obtained by granular activated carbon (GAC) documented a similar removal rate during the first four passes of aliquots containing BPA. However, the ability of GAC to remove BPA dropped to zero by the fifth pass while MnO₂ continued removing BPA.

### EXAMPLE 2

Flow-through experiments designed to test the efficiency of manganese dioxide's BPA adsorptive as well as oxidative capacity—such as would be experienced in passage of canned food liquids through strainer—and using retention times of 1-ml/second per 10-ml aliquots illustrated an extremely high removal capacity. Capacity ranged from 100% for first-pass decreasing to 21% after passage of 50-ml of 6571 μM BPA liquid. Since the initial filtration charge contained only 0.0328 g of MnO₂, this illustrates manganese dioxide's strong oxidative and adsorptive ability.

### EXAMPLE 3

BPA removal from bottled drinking water using MnO₂ coated food preparation utensils proved extremely effective. Coatings containing as little as 0.02 grams MnO₂ with stir times of one minute proved capable of removing an average of 75% of the BPA from a 10-ml water sample. Using the same technique testing a 0.5-liter single serving of bottled water contaminated with 3285 μM BPA showed removal rates from 18% for a 1-minute stir time to over 80% with a 25 minute stir time. Coatings of MnO₂ may be applied using food safe adhesives or electrochemically deposited onto metal cooking utensils.

### EXAMPLE 4

Measurements of the BPA in one serving of canned chicken noodle soup dropped 97% with less than one-minute of stirring with a MnO₂ coated utensil. This large removal rate was obtained when BPA adsorbed onto the fat molecules in the soup and were thus more easily brought into contact with the MnO₂ coated stirring utensil. This is explained by the fact that in BPA, the benzene end is hydrophobic (fat-soluble) and the hydroxyl end is hydrophilic (water-soluble), so the BPA molecule acts as to some extent as a surfactant. This surfactant-like ability solublizes the fat in the soup accelerating contact with the MnO₂ on the food preparation utensil thus facilitating the reaction. The liquid drained from canned mushrooms also showed a reduction in BPA concentration after stirring with a MnO₂ coated spoon. BPA concentrations dropped over 32% with less than one-minute of stirring with a MnO₂ coated utensil. BPA removal rates from foods were dependent upon the food's pH, fat content, the amount of MnO₂ on the cooking utensil, and the amount of stirring time.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. Manganese dioxide may be used to oxidatively attack and remove the organic compound Bisphenol A (BPA) from canned foods and bottled beverages including, but not limited to, bottled drinking water.
